(19) United States
(12) Patent Application Publication
(10) Pub. No.: US 2016/0142863 A1
(43) Pub. Date: May 19, 2016

(54) SMART CLOTHING CAPABLE OF VISUALLY DISPLAYING INFORMATION ON FLEXIBLE DISPLAYS WHILE RECEIVING WIRELESS SIGNALS FROM ONE OR MORE MOBILE DEVICES OR MOBILE SENSORS

(71) Applicant: Vinh M. G. Lam, Hayward, CA (US)

(72) Inventor: Vinh M. G. Lam, Hayward, CA (US)

(21) Appl. No.: 14/543,547

(22) Filed: Nov. 17, 2014

(51) Int. Cl. H04W 4/00; G09G 3/32; H04W 4/02

(52) U.S. Cl. CPC H04W 4/008; H04W 4/02; G09G 3/3208; G09G 2380/02

(57) ABSTRACT

In some implementations, an article of clothing includes material and a display integrated with the material. The display can include a wireless receiver configured to receive wireless signals from an associated mobile device, a flexible screen, and one or more processors. The one or more processors can be configured to determine a plurality of images based on the wireless signals, when the wireless signal includes time intervals, associate each time interval with a corresponding image from the plurality of images, when the wireless signal does not include time intervals, associate a predefined time interval with each of the plurality of images, and update operating parameters of the flexible display to present the plurality of images in accordance with an associated time interval.

### TECHNICAL FIELD

This disclosure relates to mobile visual communicating devices comprising of articles of smart clothing integrated with flexible electronic display screens capable of receiving wireless data from one or more mobile devices or sensors.

### BACKGROUND

Sport fans have a fanatical desire to cheer and support the players on the field during sport games and tournaments. For example, some sport fans bring handmade sport signs with team logos and messages to show their support or derision toward the opposing team. These sport signs are frequently made of papers, cardboard, or other material that can be heavy, prone to being damaged by wind and/or rain, and are usually too large or unwieldy to carry around in a sports stadium. Moreover, after a game, most sport signs are thrown away, which can be viewed as a waste of material and/or resources. In addition, the excessive time and labor needed to generate the sign can be viewed as also wasted.

### SUMMARY

Flexible displays are recent inventions within the last decade which allows a screen to be made very thin, light weight, and flexible. For example, flexible displays include organic light emitting diode (OLED) displays. This OLED display screen can be attached to a curved substrate. As described in this disclosure, OLED display screens can even be attached to clothing such as T-shirt or jackets. To address some issues with the prior art, flexible display in clothing would save material resources because signs can be created digitally on a flexible screen (e.g., OLED screen) which is attached or otherwise integrated into the cloths. In some implementations, a mobile device can include applications that enable users to create the images or messages. In these instances, the mobile device can wirelessly transmit the images to an article of clothing including a flexible screen. For example, a mobile device can transmit images to an OLED display screen integrated in an article of clothing using, for example, a Bluetooth wireless connection.

As previously mentioned, some implementations comprises of an OLED shirt being wirelessly linked to a mobile device using Bluetooth wireless connection. The OLED or Organic Light Emitting Diode display screen, which is lightweight, flexible, and very thin, is attached to clothing such as a shirt or a jacket. A mobile device transmits an image (e.g., sports sign, message) to the OLED shirt using Bluetooth wireless transmission or other wireless transmissions. The image is displayed on the OLED shirt. In doing so, sport fans at sport games can communicate with their favorite teams and with other sport fans with greater versatility. In some implementations, the OLED shirt may serve as a communication tool for disabled people such as, for example, people who are unable to hear or speak. In some implementations, the OLED shirt can display medical information for medical first responders during, for example, an emergency. In some implementations, the OLED can display vital signs based on physiological sensors which allow physicians and/or nurses to better monitor the condition of the wearer of the OLED shirt. In some cases, individuals can communicate information using these messages such as individuals who are unable or unwilling to verbally communicate. In these implementations, the sport fans, the patients, or disable people will use less time, less effort, and less cost in creating numerous digital images and visual information and messages that can be updated easily on their OLED shirt, enabling greater speed, flexibility, and fluidity in communicating and transmitting vital information.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an example system for presenting images on an article of clothing.

FIG. 2 is an example display system.

FIG. 3 is an example system for presenting images on multiple articles of clothing.

FIG. 4 is a flow chart illustrating an example method for presenting images on article of clothing.

FIG. 5 is an example system for presenting vital signs of an individual.

Like reference symbols in the various drawings indicate like elements.

### DETAILED DESCRIPTION

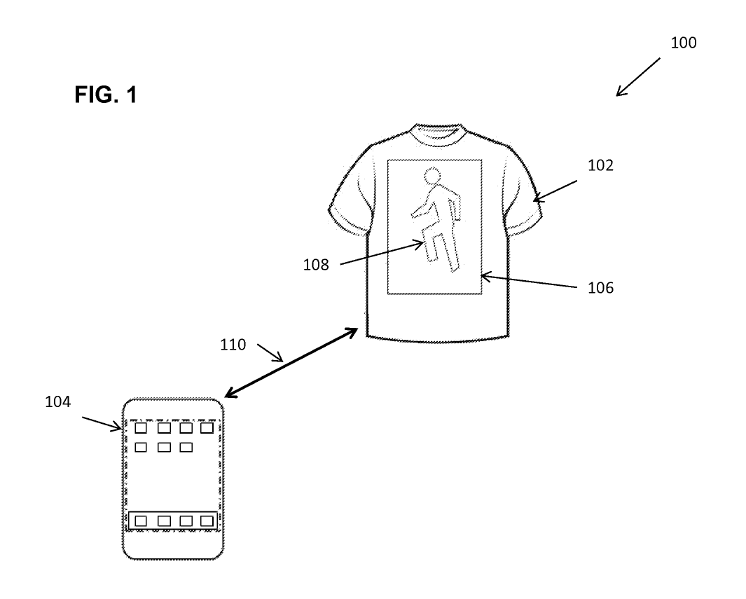

FIG. 1 is an example system 100 for presenting imaging on an article of clothing. As illustrated, the system 100 includes a shirt 102 having a flexible display communicably coupled to a mobile device 104. In some implementations, the system mobile device 104 wirelessly transmits one or more images 108 to the flexible display 106 and the flexible display 106 presents the image 108. In some cases, the mobile device 104 transmits a plurality of images 108 to the flexible display 106, which are presented in accordance with defined time periods. For example, the wireless device 104 may transmit the time periods for each image or the flexible display 106 may include predefined time periods. In some implementations, the flexible display 106 performs one or more of the following: receives a plurality of images 108 from the mobile device; determines time periods associated with the plurality of images; and presents the images in accordance with the time periods.

Turning to a detail description of the system 100, the article of clothing 102 short-sleeved shirts, long-sleeved shirts, t-shirts, hooded shirts, sweaters, sweat shirts, jeans, pants, sweat pants, jackets, coats, uniforms, rain gear, vests, outerwear, tank tops, robes, under garments, neckties, suspenders, socks, shoes, boots, skippers, sandals, scarves, jerseys and athletic uniforms, gloves, mittens, stockings, pajamas, night shirts, skirts, belts, caps, hats, baseball caps, visors, head bands and sweatbands, ear muffs, bandanas, bibs, or any other covering designed to be worn on a person's body. In addition, the article of clothing 102 can be made out of natural material, synthetic material, or a combination thereof. For example, the article of clothing 102 can be made from cotton, flax, wool, hemp, ramie, silk, lyocell, synthetic fibers (e.g., polyester, nylon), down, fur, paper, jute, rubber, PVC, bamboo, soy, or any other material and combinations thereof.

The mobile device 104 may be referred to as mobile electronic device, user device, mobile station, subscriber station, portable electronic device, mobile communications device, wireless modem, smart phone, or wireless terminal. Examples of a mobile device 104 may include a cellular phone, personal data assistant (PDA), mobile device, laptop, tablet personal computer (PC), pager, portable computer, portable gaming device, wearable electronic device, or other mobile communications device having components for communicating voice or data via a wireless communication link 110. The wireless link 110 may be over a licensed spectrum or over an unlicensed spectrum. For example, the wireless link 110 may be a Bluetooth® link, a near-field communication (NFC) link, or other links that enable direct communication between the mobile device 104 and the flexible display.

In some implementations, the mobile device 104 includes a software application that can generate images such as messages or sport signs. For example, the software application may be a computer-aided design (CAD) program. For custom programs, those skilled in the art of developing mobile device applications will be able create a software applications that has a very friendly user interface that allow the sport fan to create sport sign messages easily and quickly. Once the mobile device has created the image 108 on the mobile device 102 using the software application, the image 108 can be wirelessly transmitted to the flexible display 108.

Other examples of a mobile device 104 include, but are not limited to, a television, a remote controller, a set-top box, a computer monitor, a computer (including a tablet, a desktop computer, a handheld or laptop computer, a netbook computer), a microwave, a refrigerator, a stereo system, a cassette recorder or player, a DVD player or recorder, a CD player or recorder, a VCR, an MP3 player, a radio, a camcorder, a camera, a digital camera, a portable memory chip, a washer, a dryer, a washer/dryer, a copier, a facsimile machine, a scanner, a multi-functional peripheral device, a wristwatch, a clock, and a game device, etc. A mobile device 104 may include a device and a removable memory module, such as a Universal Integrated Circuit Card (UICC) that includes a Subscriber Identity Module (SIM) application, a Universal Subscriber Identity Module (USIM) application, or a Removable User Identity Module (R-UIM) application. The term “UE” can also refer to any hardware or software component that can terminate a communication session for a user. In addition, the terms “user equipment,” “UE,” “user equipment device,” “user agent,” “UA,” “user device,” and “mobile device” can be used synonymously herein.

The flexible display 108 integrated in the article of clothing 102 is configured to be flexible and present images 108 received from the mobile device 102. The flexible display 108 may be based on OLED technology, flexible organic flash memory technology, electrophoretic technology, electrowetting technology, or other technologies. For example, the flexible display 108 may be an Organic Light Emitting Diode (OLED) display screen that is attached or other integrated in the shirt 102. OLED screen are widely available and can be purchased from many suppliers. OLED display screens are very flexible, thin, and light weight, which allow them to be attached to curved surfaces or fabric substrate. LG, Universal Display Corporation, Phillip Lighting, and Samsung manufacture this type of high quality OLED display screen. Manufacturers in China have also begun to manufacture thin flexible OLED screens, making OLED screen even less expensive and more widely available. Other manufacturers also manufacture thin flexible OLED screens that are capable of being attached to clothing. In some implementations, the flexible display 108 is attached to or otherwise integrated into the shirt or any other piece of clothing. In some implementations, the flexible display 108 can be sewed onto the shirt, clipped onto the shirt, taped onto the shirt, glued onto the shirt using adhesives, attached using fasteners, or other methods. In another embodiment, the flexible display 108 can be attached to the shirt using loop-and-hook fasteners. There are many different ways to integrate a flexible screen to an article of clothing, and different clothing fabric may require different attachment methods.

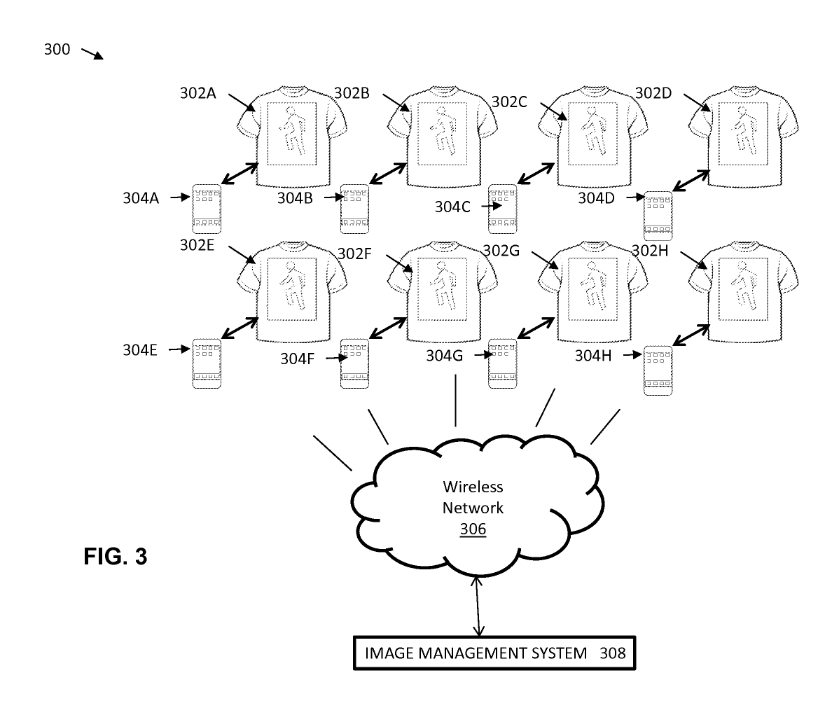

In some aspects of operation, a user of the mobile device 102 generates one or more images 108 using software running on the mobile device 102. In some implementations, the mobile device 102 may receive images 108 from other sources, which is discussed in connection with FIG. 3. The software may request time periods associated with the images through, for example, a selectable window. Once generate, the mobile device 102 transmits the images 108 and any associated time to the flexible display 108. In response to the images, the flexible display 108 determines whether the signal includes associated time periods. If not, the flexible display 108 may identify a predefined time periods for the images. Regardless, the flexible display 108 presents the images 108.

In some implementations, the mobile device 102 may control images presented on multiple shirts 102. In this configuration, the software application may create multiple images (e.g., sports messages) and then wirelessly transmits these messages to, for example, multiple OLED shirts, using wireless links (e.g., Bluetooth®). By enabling a sports fan to generate multiple messages on multiple OLED shirts, the sports fan can create an enormous variety of sport sign expression. In these implementations, the sports fans may give permission to one single sports fan to control all the OLED shirts. This single sports fan with his one mobile device 102 would gain access to all the OLED shirts, allowing this one mobile device to create a longer sports sign message using all the OLED shirts in the group of sport fans. For example, the mobile device 102 may control 7 different OLED shirts using, for example, Bluethooth wireless transmissions. In this example, the mobile device 102 can generate 7 letters, with each letter shown on one OLED shirt. For instances, the mobile device 102 can generate the word “VICTORY” on the 7 OLED shirts, with each shirt taking on one letter. So, the first OLED shirt would display the letter “V”; the second OLED shirt would display the letter “I”; the third OLED shirt would display the letter “C”; the fourth OLED shirt would display the letter “T”; the fifth OLED shirt would display the letter “O”; the sixth OLED shirt would display the letter “R”; the seventh OLED shirt would display the letter “Y”. As a result, the word “VICTORY” is generated on one the mobile device 102 and is transmitted to 7 OLED shirts to display each letter in large size on each OLED shirt. At a distance in the sport stadium, these sport messages would be visible.

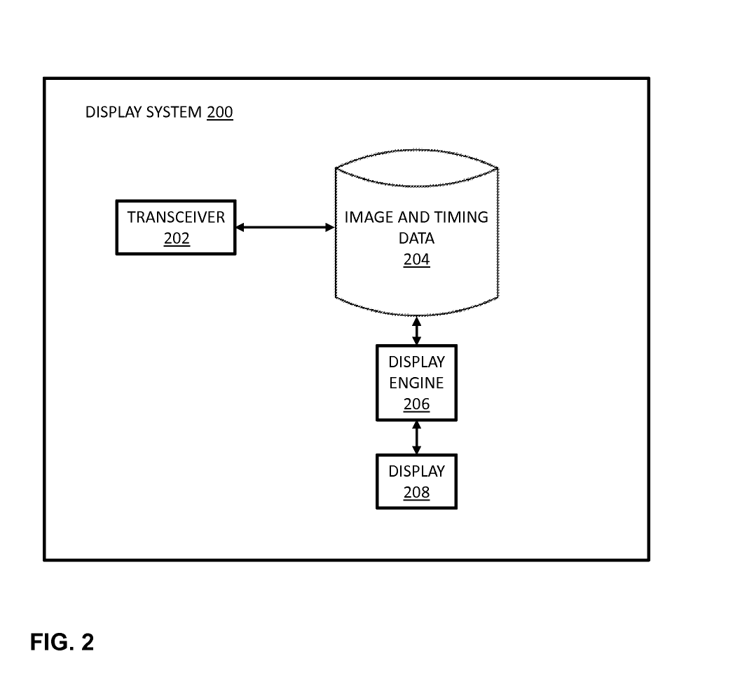

FIG. 2 is an example display system 200 for displaying images on an article of clothing such as the shirt 102 of FIG. 1. In particular, the display system 200 includes a transceiver 202 for wireless communication, repository 204, a display engine 206 for updating operating parameters of the flexible display 208. The transceiver 202 may wirelessly communicate directly with devices such as mobile device 104 or through a wireless network (e.g., cellular network, broadband network). Once received, image and timing data is stored in the repository 204. The display engine 206 retrieves images and timing data from the repository 204 and updates operating parameters of the flexible display 208 to present images.

FIG. 3 is an example system 300 for displaying images on multiple flex-screen shirts 302a-h. For example, the system 300 may display the same or different images on the flex-screen shirts 302a-h. As illustrated, the mobile devices 304a-h are communicably coupled to the image management system 308 through the wireless network 306. The image management system 308 may distribute images and/or timing information to the mobile devices 304a-h using the wireless network 306. The mobile devices 304a-h directly transmit received images to associated flex-screen shirts 302a-h. In some aspects of operation, the image management system 308 may transmit a request to display images to the mobile devices 304a-h. In response to user selections, the mobile devices 304a-h transmits response to the image management system 308. The image management system 308 transmits images to participating flexible-screen shirts 302. In some implementations, the image management system 308 may request location information (e.g., seat number) and present images that are spatially coordinated.

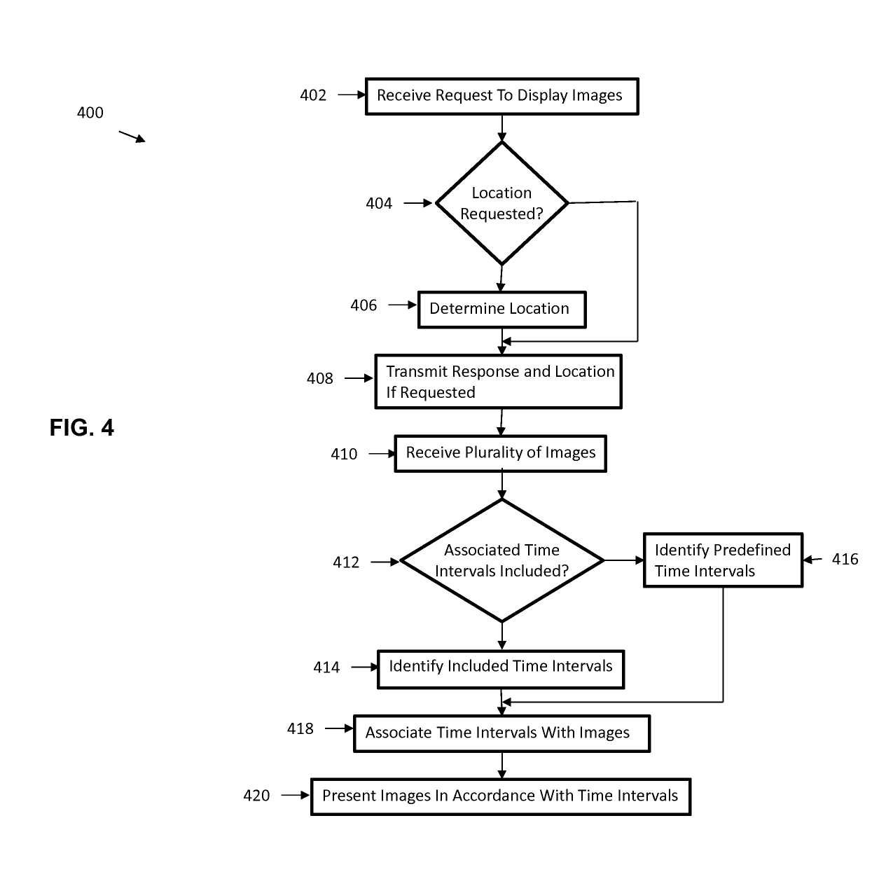

FIG. 4 is a flow chart illustrating an example method 400 for presenting images on an article of clothing. Generally, method 400 describes example techniques for the mobile device 104 and the flexible display 106 to generate, transmit, and/or present images through the article of clothing 102. The following descriptions will focus on the operation of the mobile device 104 and the flexible display 106 in performing this method. But systems 100, 200, and 300 contemplates using any appropriate combination and arrangement of logical elements implementing some or all of the described functionality.

Method 400 begins at step 402 where a request to display images is received. For example, the mobile device 104 may receive a request to display images, or the flexible display 106 may receive a request to display images. If a location is requested at decisional step 404, a location is determined at step 406. In the example, the mobile device 104 may determine a location using, for example, GPS or requesting seat information from the user. If a location is not requested at step 406, execution proceeds to step 408. A response and any requested location information is transmitted at step 408. For example, the mobile device 304 may transmit a response to the image management system 308 through the network 306. Next, at step 410, a plurality of images are received. Returning to the example, the mobile device 304 may receive a plurality of digital media files from the image management system 308. If associated time intervals are included at decisional step 412, the included time intervals are identified at step 414. In the example, the mobile device 304 may determine that the digital media files include images and associated time intervals. If associated time intervals are not included at decisional step 412, the mobile device 304 or the flexible display 302 may identified predefined time intervals at step 416. At step 418, the identified time intervals are associated with images. For example, the mobile device 104 may associate time intervals for each image. Next, at step 420, the images are presented for the duration of their associated time intervals. For example, the flexible display 106 may cycle through the images based on the associated time intervals.

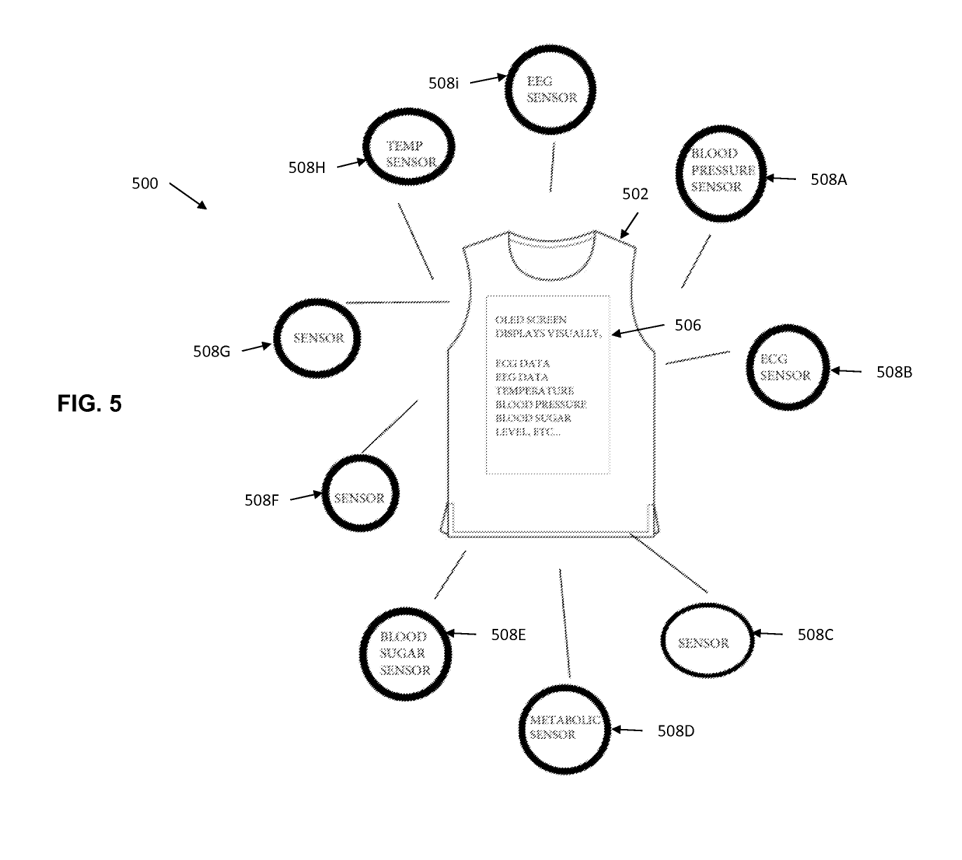

FIG. 5 is an example system 500 for displaying vital signs of an individual. For example, the system 500 may display vital signs in response to an emergency. As illustrated, the system 500 includes an article of clothing 502 including a flexible display 504 communicably coupled to a plurality of wireless sensors 508a-i. The wireless sensors 508a-i are configured to measure or otherwise detect operating parameters of an individual and wireless transmit values for the operating parameters and/or images to the flexible display 504 in response to an event. The event can include at least one of a period of time, an abnormal measurement, a request, or others. In some implementations, the article of clothing 502 including the flexible display 504 comprises an OLED shirt. In these instances, the OLED shirt 502 may receive a request to transmit visual images from mobile wireless physiological sensors 508a-i that monitor the wearer's vital sign. For example, the physiological sensors 508a-i may transmit the visual information using, for example, Bluetooth® or other wireless signals. The mobile wireless physiological sensors 508a-i may transmit different types of vital data to the single OLED shirt 502, which display these various vital sign data in visual form on the OLED flexible screen 504. The OLED shirt 502 may serve as a communication device between physiological sensors 508a-i and the medical personnel. For example, the OLED shirt 502 may receive data transmitted telemetrically from the ECG sensor 508 attached to a patient's chest to detect arrhythmias (e.g., heart attacks). The physiological sensors 508a-i may detect other sensors such as a temperature sensor 508h to detect fever, a blood pressure sensor 508a, an EEG sensor 508i to detect abnormal brain activity (e.g., epileptic seizure), a blood glucose sensor 508e to monitor blood sugar levels (e.g., diabetic conditions), a chemical sensor 508c to detect chemical changes in excretions (e.g., metabolic changes in patent sweat), or others.

In some implementations, the OLED shirt 502 can constantly update these physiological visual information or associated values. As a result, the OLED shirt 502 may reduce the number of large bulky medical monitoring equipment typically found in the traditional clinical setting and may provide savings in cost and space in a hospital setting. Furthermore, transporting the patient around may be also easier when the OLED shirt 502 replaces bulky and heavy traditional medical monitoring equipment. In addition, the OLED shirt 502 may also be useful for monitoring patients in third world countries where medical infrastructure is lacking, because it may provide an inexpensive method of displaying patient's vital signs and physiological conditions in developing countries especially in poor rural areas.

A number of embodiments of the invention have been described. Nevertheless, it will be understood that various modifications may be made without departing from the spirit and scope of the invention. Accordingly, other embodiments are within the scope of the following claims.

1. A article of clothing, comprising:
a plurality of physiological sensors configured to affix to a patient, measure activity of a patient, and wirelessly transmit a status in response to abnormal measurements;
material; and
a display integrated with the material and comprising:
a wireless receiver configured to receive the status from the plurality of physiological sensors;
a flexible screen; and
one or more processors configured to:
determine a plurality of images based on the status;
and
update operating parameters of the flexible display to present the plurality of images to alert others of the abnormal measurements.

2. The article of clothing of claim 1, further comprising:
a wireless transmitter; and
the one or more processors further configured to:
determine the status includes a request to present images; and
transmit a response using the wireless transmitter.

3. The article of clothing of claim 2, the one or more processors further configured to:
determine the status includes a request for a location;
determine a current location; and
transmit the location using the wireless transmitter.

4. The article of clothing of claim 1, wherein the plurality of images comprise presentation of the status as a function of time.

5. The article of clothing of claim 1, wherein the flexible screen comprises an organic light emitting diode (OLED) screen.

6. The article of clothing of claim 1, wherein the status comprises a Bluetooth signal.

7. (canceled)

8. (canceled)

9. A physiological sensor, comprising:
fasteners to affix to a patient;
detectors to measure a status of a patient;
a wireless transceiver configured to wireless communicate with an article of clothing including a flexible display; and
one or more processors configured to:
determine the measured status of the patient indicates abnormal measurements;
wirelessly transmit, to the article of clothing, operating parameters for the flexible display to present plurality of images based the abnormal behavior.

10. The mobile device of claim 9, the one or more processors further configured to:
determine the status includes a request to present images; and
transmit a response using the wireless transceiver.

11. The mobile device of claim 9, the one or more processors further configured to:
determine a current location; and
transmit the location with the status using the wireless transceiver.

12. (canceled)

13. The mobile device of claim 11, wherein the one or more processor configured to determine a current location comprises the one or more processors configured to use a Global Positioning System (GPS) to determine coordinates.

14. The mobile device of claim 9, wherein the plurality of images comprise the status as a function of time.

15. The mobile device of claim 9, wherein the operating parameters are for an organic light emitting diode (OLED) display.

16. The mobile device of claim 9, wherein the operating parameters are transmitted using a Bluetooth signal.

17. (canceled)
